(19) United States
(12) Patent Application Publication
(10) Pub. No.: US 2010/0109601 A1
(43) Pub. Date: May 6, 2010

(54) PORTABLE SOLAR ELECTRICAL GENERATOR AND WATER FILTRATION AND DESALINATION SYSTEM

(76) Inventors: Eugene M. Coyle, Wilmington, NC (US); James A. Starr, Soquel, CA (US); Jeff A. Lipton, Berkeley, CA (US); Matthew J. Quirk, Emeryville, CA (US); David C. Johnson, Lafayette, CA (US)

Correspondence Address: STOEL RIVES LLP - PDX, 900 SW FIFTH AVENUE, SUITE 2600, PORTLAND, OR, 97204-1268, US

(21) Appl. No.: 12/611,026

(22) Filed: Nov. 2, 2009

Related U.S. Application Data
(60) Provisional application No. 61/110,865, filed on Nov. 3, 2008.

(51) Int. Cl. H02J 7/04; B01D 35/26; B60P 3/06; H01M 10/46

(52) U.S. Cl. 320/102; 210/541; 210/143; 280/402; 320/101; 180/65.29

(57) ABSTRACT

A portable solar power collection and storage system integrated into a body affixed to a towable trailer vehicle, which in a preferred configuration may require no complicated setup steps or even no setup steps at all, and may be not wind vulnerable due to integrated body construction with substantially contained rather than extended solar panel(s). The system may further include water pumping and treatment equipment.

### RELATED APPLICATION DATA

This application claims priority to U.S. provisional application No. 61/110,865 filed Nov. 3, 2008, hereby incorporated by reference.

### BACKGROUND

The field of the present disclosure relates to photovoltaic electrical generation or more particularly to portable renewable electrical power generation and water purification and desalination systems.

Various apparatus have been introduced to address the need for renewable energy power generation and water treatment, but the present inventors have recognized that all suffer shortcomings in various ways.
OK Solar, Solar Cube, Solar OnLine Australia, World Water and Mobile Solar Power offer trailer mounted solar power generation equipment that requires setup time and capability and exposes collector panel arrays to wind damage.
Power Cube 600 from Reluminati offers deployable array of solar collectors from a box they call portable, but which weighs 2000 lb. This unit is not very portable and exposes panels to wind damage.
Saraceno U.S. Pat. No. 6,863,827 (2005) describes a portable system with solar collection and water purification but is limited to time delay operation and a cabinet-sized frame not suitable for larger capacity applications.
Browe U.S. Pat. No. 7,150,153 (2006) describes a similar cart mounted system but it lacks integrated solar collectors and requires wind-vulnerable externally deployed array.
Gidden et al U.S. Pat. No. 5,969,501 (1999) describes a cart-mounted system similar to Browe, with the same deficiencies.
First Water systems describes a cart-mounted system similar to Browe's and having deficiencies.

### SUMMARY

The present invention is directed to a portable photovoltaic electricity generator, storage, and delivery system. Preferred embodiments may include:
Integrated water treatment system.
Integrated shunt system to pump water to store or utilize additional electricity generated after system batteries are fully charged.
Auxiliary input from other sources of electricity for storage or pumping.
Integrated switch or switches to allow the user to select power output and operating options.
Integrated monitoring and data collection system to track system power generation and operating parameters. The monitoring and data collection system may have the ability to remotely notify user(s) of system usage metrics through an Internet connected wireless modem or mobile telephony data network.

A preferred portable system is a solar power collection and storage system configured in a body with all elements contained and mounted without substantial extensions and protrusions that preferably requires no or minimal setup and is not wind vulnerable, and may contain water pumping and water treatment equipment.

### BRIEF DESCRIPTION OF THE DRAWINGS

FIG. 1 is a side perspective view of a portable photovoltaic generator system according to a preferred embodiment;

FIG. 2 is a top perspective view of the system of FIG. 1, shown with the photovoltaic collector panel removed for visibility of one arrangement of major internal components;

FIG. 3 is a block diagram of the major functional elements of one embodiment of portable photovoltaic generator station with water pumping and water treatment equipment.

FIG. 4 is a side view of a portable photovoltaic generator system, shown in an optional position oriented about an included axis of rotation to accomplish elevation angle adjustment to better absorb incident solar radiation.

### DETAILED DESCRIPTION OF THE PREFERRED EMBODIMENTS

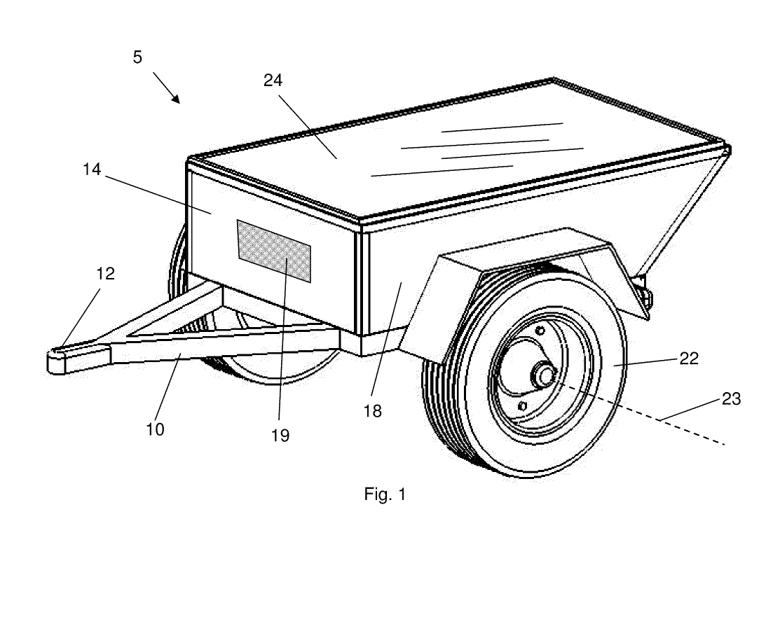

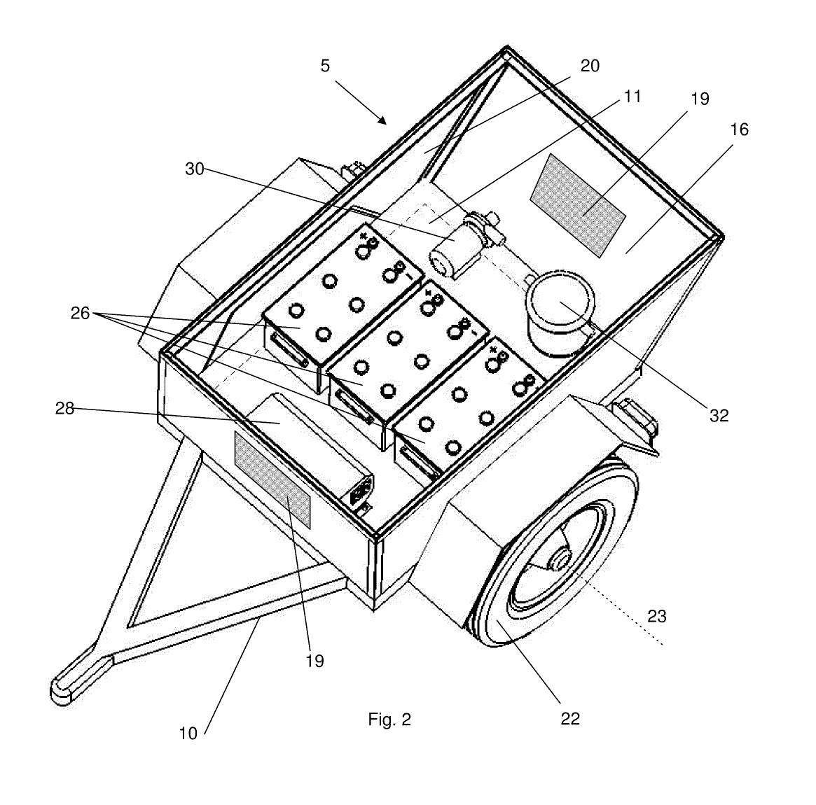

Details of the preferred embodiments will now be described with reference to the drawings. FIG. 1 and FIG. 2 illustrate a mobile photovoltaic electricity generator station 5 constructed on a trailer 10 and arranged to contain the major system functional elements, and having one or more photovoltaic solar collector panels 24, such as Sharp model number ND-224U1F, affixed to the upper part of the trailer body such as HaulMaster model 2575, without extending away from that body in such a manner as to be vulnerable to common wind forces. The station 5 includes the trailer 10 having a trailer hitch 12, a trailer body or bed (comprised of a front body surface or wall 14, a rear body surface 16, a side surface 18 and an opposing side surface 20), and a plurality of wheel assemblies 22 with a wheel assembly rotation axis 23. Each of the front, rear, and side surfaces 14, 16, 18, and 20 are connected to form an enclosed space inside the trailer 10 for containing and protecting other system elements.

FIG. 2 illustrates the station 5 of FIG. 1 with the photovoltaic solar collector panel, designated as item 24 in FIG. 1, removed to reveal the enclosed space inside the trailer 10, and a preferred arrangement of some of the internal elements. A multiplicity of batteries 26, such as Deka model MK S8D G LTP, inverter 28, such as Wagan Tech model Industrial 5000, and any optional self-priming electric pump 30 with suitable voltage and current requirements, and water treatment equipment 32 are disposed about the wheel assembly rotation axis 23 such that the sum of their individual weights multiplied by their individual distances fore or aft of said axis results in a balance of the trailer 10 as a whole around that axis that provides downward force at hitch 12 for secure hitch attachment to the towing vehicle and limits that downward force at the hitch 12 to an amount suitable for human lifting of the trailer hitch for tilting about the axis of rotation 23 for elevation orientation toward the sun. Water treatment equipment 32 preferably includes water purification filters such as General Electric model GXSV65F, or a reverse osmosis water purification system such as General Electric model Merlin 320, or a water desalinator such as those used in marine applications.

Still referring to FIGS. 1 and 2, the enclosure formed by the front, rear, and side surfaces 14, 16, 18, and 20 of the trailer assembly 10, combined with the upper enclosing surface formed by the photovoltaic collector panel 24 and the floor 11 of the trailer 10 are arranged to be sufficiently ventilated by ventilation ports 19 in any of the said enclosure surfaces 14, 16, 18 or 20, or floor 11, so as to maintain suitable operating temperature for the components 26, 28, 32, as well as any other temperature sensitive items which may be installed therein.

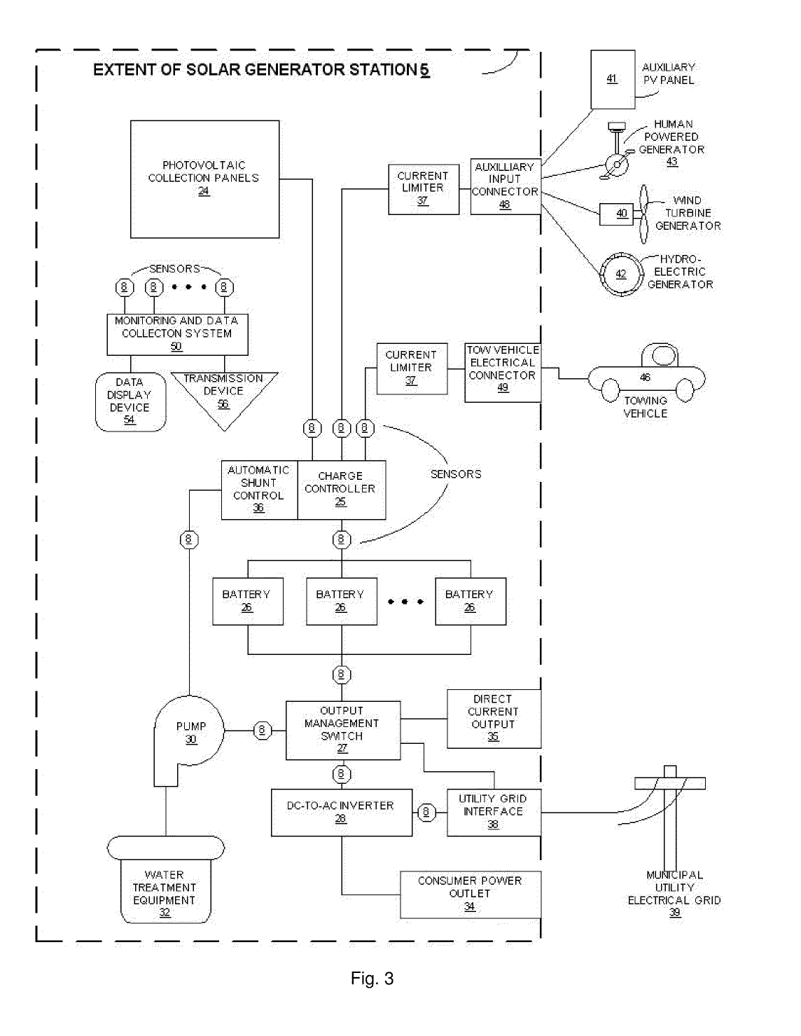

Also in further detail, now referring to the diagram in FIG. 3, a number of photovoltaic panels 24 is an electrical power source that provides electrical power to charge controller 25, with an optional sensor 8 monitoring the amount of electrical current collected from panels 24. Additionally, various external power sources of direct current, such as a wind turbine generator 40, additional photovoltaic panels 41, hydroelectric generator 42, and human powered generator 43, may be connected to generation station 5 through auxiliary direct current input connector 48. Such auxiliary direct current input may be regulated or limited to prevent damage to generation station 5 by use of current limiter 37 before such current is provided to charge controller 25. An optional sensor 8 may be used to monitor the amount of electrical current collected from such external sources. Such a current limiting device may be an off-the-shelf item or may be assembled from common components to limit passing of current to safe levels. Additionally, the power system of an external vehicle such as the towing vehicle 46 may be used as a power source, connected through towing vehicle connector 49 to charge controller 25 through another current limiter 37 with an optional sensor 8 monitoring the amount of electrical current collected through that connector. Any or all said power sources may provide electrical current to charge controller 25. Charge controller 25 manages electrical current directed to batteries 26 to properly effect charging and avoid overcharging batteries 26, and provides alternate electrical current path by included automatic shunt control system 36 when batteries 26 are fully charged and can no longer receive additional electrical current. Flexcharge Model NC25A-24 is one example a suitable off-the-shelf charge controller with such automatic shunt control. Also, batteries 26 may be arranged in various parallel and series configurations to operate at various system voltages. Optionally, a sensor 8 may be used to monitor said battery charge and shunt current. The batteries 26 provide electrical power to output management switch 27, with optional sensors 8 monitoring current so directed. The shunt control system 36 may provide electrical power to optional pump 30 in order to make use of excess power when batteries are full and cannot store any more. Output management switch 27 may be manipulated by user to guide output electrical current to various destinations, including inverter 28, optional pump 30 and optionally, water treatment equipment 32, or external direct current output connector 35, and to control passage of inverter 28 alternating current output to municipal utility electrical grid 39 through optional municipal utility grid output connector 38, with all such guided outputs optionally monitored by sensors 8. Inverter 28 may convert direct electrical current to alternating current suitable for use by common appliances and electrical equipment, and provide that alternating electric current to alternating current outlet sockets 34. Additionally, optional sensors 8, shown at multiple points, and selected to sense current or voltage, may be monitored, and have the data collected from them by monitoring system 50, comprising sufficient sensor signal processing electronics, memory, and display or transmission control electronics, such as might be found in microprocessor based data collection equipment, to report such data and make it available to users through display equipment 54 or transmit it to remote locations through transmission interface 56. Transmission interface 56 may be a common computer network connector or a radio frequency wireless interface to standard Internet communication network, or wireless telephone communication modem suitable for connection to community wireless telephone system. The term modem is used as a common designation of a modulator/demodulator device for interfacing between communication equipment and a network for transmission of such communication.

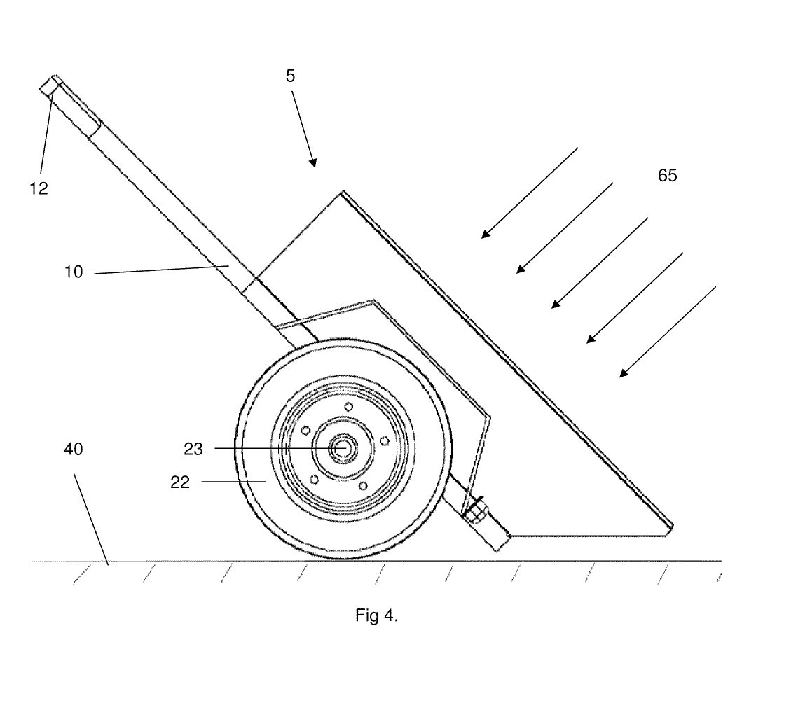

The structural components of trailer 10 of FIGS. 1, 2 and 4 may be constructed of steel or aluminum assembled by welds or suitable fasteners selected for adequate strength for safely towing the trailer assembly 10 over normal and rough road conditions. Elements shown inside the trailer assembly 10 body may be separated by internal compartment walls not shown. Construction details further include arrangement of the trailer 10 body elements such that the generator system 5 may be positioned in a tilted attitude around the axis 23 of the wheel assembly 22 to achieve directing/orienting the photovoltaic collector panel 24 substantially toward the incident solar radiation 65 when trailer hitch 12 is disconnected from the towing vehicle, as shown in FIG. 4. Suitable devices may be used to secure the trailer 10 to ground 40 in the chosen tilted attitude, such as jacks, wheel chocks or stakes and guys, if the ground is uneven or sloped. Construction details further include arrangement of heavy components such as batteries 26, inverter 28, pump 30 and water treatment equipment 32 in such a manner that balance of the assembled system in trailer 10 around the axis 23 of the wheel assembly 22 accomplishes the desirable balanced attributes of providing proper hitch weight to the towing vehicle for towing stability and allowing human powered hand positioning of the generating station 5 to adjust the elevation angle as in FIG. 4. Control elements requiring human access may be mounted on any of the described surfaces of trailer assembly 10

In a preferred configuration, the electricity generation system is designed as a mobile platform for transportation to various localities and positioning in both declination and daily solar transit to collect the solar irradiation. The system may provide power delivery and water treatment in a mobile platform by virtue of its unitized, non-wind-vulnerable, ready-to-use integrated construction with no need for user setup upon arrival at use location. It is designed for simple orientation to the solar source, complimented by an automatic shunt feature allowing for non-monitored function.

The generation station 5 in its preferred construction may provide one or more of the following advantages:

a substantially-sized solar powered generation station that is readily and conveniently movable,

the orientation of the solar power collection surface is adjustable toward incident sunshine for maximizing solar collection efficiency,

components of the station are self-contained and do not require assembly and disassembly for transport thus avoiding or minimizing setup time and difficulties,

avoiding exposure to wind damage, which is a common concern for existing deployed photovoltaic generator collector arrays,

providing a portable solar power generator that does not require a high level of user technical knowledge to setup or operate nor require wind vulnerability judgment.

In a preferred embodiment, the generation station may comprise a solar powered generator that may be transported, setup and operated by unskilled consumers, by businesses whose knowledge lies in other areas but for whom off-grid power is required, by disaster relief agencies who must deploy power generation or water treatment systems to be operated by untrained personnel in remote areas, and by remote performance venue operators where power generation is needed without normally associated audible noise. The generation system may thus have one or more of the following advantages or attributes: useful for portable, quiet, renewable energy or water treatment; a system with few or no setup requirements, no fueling requirements, and no weather protection requirements.

Though the present invention has been set forth in the form of its preferred embodiments, it is nevertheless intended that modifications to the disclosed systems and methods may be made without departing from inventive concepts set forth herein.

1. A portable solar generator system comprising:
a towable trailer vehicle with two or more wheels and a towing hitch,
one or more photovoltaic solar collection panels substantially mounted to the body of said trailer vehicle such that they are not substantially extended away from said vehicle body so as to expose them to wind damage, and
the trailer having an axis of rotation such that the elevation angle of said photovoltaic panel collector may be adjusted by rotation around that axis to more directly face the sun.

2. A portable solar generator system as in claim 1 further comprising one or more storage batteries having a direct current battery output.

3. A portable solar generator system as in claim 2 further comprising an inverter to convert the direct current battery output to alternating current.

4. A portable solar generator system as in claim 1 wherein the axis of rotation for elevation angle adjustment is the trailer vehicle wheel assembly axis.

5. A portable solar generator system as in claim 1 further comprising a water pump.

6. A portable solar generator system as in claim 5 additionally comprising water treatment equipment comprising a number of water quality treatment and filtering elements.

7. A portable solar generator system as in claim 5 additionally comprising water treatment equipment comprising a salt-water desalination device.

8. A portable solar generator system as in claim 2 additionally comprising a water pump wherein said water pump may be activated by an automatic shunt system to operate at times when said batteries are fully charged allowing solar energy converted to electricity to be directed to work instead of being stored as electrical battery charge.

9. A portable solar generator system as in claim 2 additionally comprising an auxiliary direct current input to allow for recharging of the batteries from an external power source such as a wind turbine, hydroelectric generator, human powered generator, additional photovoltaic solar collector panel, or any other appropriate power generation system.

10. A portable solar generator system as in claim 3 additionally comprising an output alternative directing generated power to an interface connected to external municipal power utility system.

11. A portable solar generator system as in claim 3 additionally containing a power monitoring system to sense and record power collection and use.

12. A portable solar generator system as in claim 11 additionally containing an Internet modem or mobile telephony radio for the wireless transmission of relevant system usage data such as power generated.

13. A portable solar generator system as in claim 2 additionally containing a current limiter and socket interface connectable to conventional trailer connections of automobiles for allowing the solar generator batteries to be recharged from the towing vehicle battery.
